(19) United States
(12) Patent Application Publication
(10) Pub. No.: US 2026/0197655 A1
(43) Pub. Date: Jul. 9, 2026

(54) METHOD OF VERIFYING CONNECTION OF DISPLAY DEVICE, CONNECTION VERIFICATION SYSTEM AND METHOD OF GENERATING CONNECTION CODE FOR DISPLAY DEVICE

(71) Applicant: Coretronic Corporation, Hsin-Chu (TW)

(72) Inventor: Wei-Tai KO, Hsin-Chu (TW)

(21) Appl. No.: 19/419,151

(22) Filed: Dec. 15, 2025

(30) Foreign Application Priority Data
Jan. 9, 2025 (CN) 202510036428X

(51) Int. Cl. H04W 12/50; H04W 4/80; H04W 76/14

(52) U.S. Cl. CPC H04W 12/50; H04W 4/80; H04W 76/14

(57) ABSTRACT

A connection verification system includes the display device and a terminal device. The display device is provided with a MAC address, generates a verification code according to the MAC address, and transmits a short-range wireless signal including the MAC address. The terminal device receives the short-range wireless signal and generates a connection code according to the MAC address. The terminal device transmits the connection code to the display device, and the display device determines whether to be wirelessly connected to the terminal device according to the connection code and the verification code. By the aforementioned configuration, it can be ensured that the display device is prevented from the access and the manipulation of the terminal device which does not undergo security verification.

### CROSS REFERENCE TO RELATED APPLICATION

This application claims the priority benefit of Chinese Patent Application Serial Number 202510036428X, filed on 9th, January, 2025, the full disclosure of which is incorporated herein by reference.

### BACKGROUND

### Technical Field

The disclosure is related to the field of display devices and is particularly related to a method of verifying a connection of a display device, a connection verification system and a method of generating a connection code for a display device.

### Related Art

Bluetooth technology is a wireless communication technology widely used between electronic devices. Bluetooth allows the electronic devices to build a short-range wireless connection between themselves to perform data transmission and is widely applicable to various fields such as earbuds, a smart phone, a television, and a projector. As the progress of technology, the purposes of Bluetooth rise significantly, e.g., the connection of the electronic device and the earbuds, the positioning of the electronic devices, the recognition of the electronic devices and audiovisual interaction.

At present, the Bluetooth connection may include a connection without security verification mechanism and a connection with the security verification mechanism. In the connection without the security verification mechanism, two electronic devices with Bluetooth may directly build the wireless connection between themselves by a simple pairing process; hence, the connection without the security verification mechanism is adapted to scenes with a low security risk. In the connection with the security verification mechanism, two electronic devices with Bluetooth require identity authentication by using a personal identification number (PIN) during the connection; hence, the connection with the security verification mechanism is adapted to scenes with a high security risk.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In light of the aforementioned description, the disclosure provides a method of verifying a connection of a display device, a connection verification system and a method of generating a connection code for a display device to solve the problem of the security of the Bluetooth connection of the display device, for example projector, during a shutdown mode or a standby mode.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

In order to achieve one, one part or all of the objectives, the method of verifying the connection of the display device in one embodiment of the disclosure includes: performing steps as follows by the display device with a MAC address: according to the MAC address, generating a verification code; transmitting a short-range wireless signal comprising the MAC address; according to a connection code transmitted from a terminal device and the verification code, determining whether to be wirelessly connected to the terminal device; performing steps as follows by the terminal device: receiving the short-range wireless signal with the MAC address; generating the connection code according to the MAC address; transmitting the connection code to the display device.

In an embodiment of the disclosure, determining whether to be wirelessly connected to the terminal device according to the connection code and the verification code includes: determining whether the connection code is the same as the verification code; in response to the connection code being determined to be the same as the verification code, wirelessly connecting the display device to the terminal device; and in response to the connection code being not determined to be the same as the verification code, not wirelessly connecting the display device to the terminal device.

In an embodiment of the disclosure, the method of verifying the connection of the display device further includes: controlling the display device by the terminal device in response to the display device being wirelessly connected to the terminal device.

In an embodiment of the disclosure, the method of verifying the connection of the display device further includes : performing steps as follows by the terminal device: receiving at least one short-range wireless signal transmitted from at least one display device; and according to at least one RSSI of the at least one short-range wireless signal, displaying, in a list, the at least one display device of which the at least one RSSI is greater than a default threshold value, and the at least one display device includes the display device.

In an embodiment of the disclosure, displaying the at least one display device of which the RSSI is greater than the default threshold value in the list according the at least one RSSI of the at least one short-range wireless signal includes: determining whether the at least one RSSI of the at least one short-range wireless signal is greater than the default threshold value; in response to the at least one RSSI of the at least one short-range wireless signal being determined to be greater than the default threshold value, classifying the at least one short-range wireless signal of which the at least one RSSI is greater than the default threshold value as at least one first short-range wireless signal, and classifying the at least one display device corresponding to the at least one first short-range wireless signal as at least one first class display device; and displaying the at least one first class display device in the list, and the at least one first class display device includes the display device.

In an embodiment of the disclosure, displaying the at least one display device of which the at least one RSSI is greater than the default threshold value in the list according the at least one RSSI of the at least one short-range wireless signal includes: in response to the RSSI of the short-range wireless signal being not determined to be greater than the default threshold value, classifying the at least one short-range wireless signal of which the at least one RSSI is not greater than the default threshold value as at least one second short-range wireless signal, and classifying the at least one display device corresponding to the at least one second short-range wireless signal as at least one second class display device; and not displaying the at least one second class display device.

In an embodiment of the disclosure, the display device is configured to continuously transmit the short-range wireless signal in response to the display device being in a shutdown mode or a standby mode.

In an embodiment of the disclosure, generating, by the display device, the verification code according to the MAC address includes: inputting the MAC address into an encryption algorithm, and utilizing an encryption key to perform calculation on the MAC address by the encryption algorithm in order to generate the verification code.

In an embodiment of the disclosure, generating, by the terminal device, the connection code according to the MAC address includes: inputting the MAC address into an encryption algorithm, and utilizing an encryption key to perform calculation on the MAC address by the encryption algorithm in order to generate the connection code.

In order to achieve one, one part or all of the objectives, the connection verification system in one embodiment of the disclosure includes the display device and the terminal device. The display device is provided with the MAC address. The display device is configured to generate the verification code according to the MAC address, and to transmit the short-range wireless signal including the MAC address. The terminal device is wirelessly connected to the display device. The terminal device is configured to receive the short-range wireless signal and to generate the connection code according to the MAC address. The terminal device is configured to transmit the connection code to the display device, and the display device is configured to determine whether to be wirelessly connected to the terminal device according to the connection code and the verification code.

In an embodiment of the disclosure, the display device is configured to determine whether the connection code is the same as the verification code. In response to the connection code being determined to be the same as the verification code, the display device is wirelessly connected to the terminal device; in response to the connection code being not determined to be the same as the verification code, the display device is not wirelessly connected to the terminal device.

In an embodiment of the disclosure, the terminal device is configured to control the display device in response to the display device being wirelessly connected to the terminal device.

In an embodiment of the disclosure, at least one display device is configured to transmit at least one short-range wireless signal to the terminal device, the terminal device is configured to display the at least one display device of which at least one RSSI is greater than a default threshold value in a list according to the at least one RSSI of the at least one short-range wireless signal, and the at least one display device includes the display device.

In an embodiment of the disclosure, the terminal device is configured to determine whether the at least one RSSI of the at least one short-range wireless signal is greater than the default threshold value. In response to the at least one RSSI of the at least one short-range wireless signal being determined to be greater than the default threshold value, the terminal device is configured to classify the at least one short-range wireless signal of which the at least one RSSI is greater than the default threshold value as at least one first short-range wireless signal, and to classify the at least one display device corresponding to the at least one first short-range wireless signal as at least one first class display device. The terminal device is configured to display the at least one first class display device in the list, and the at least one first class display device includes the display device.

In an embodiment of the disclosure, in response to the at least one RSSI of the at least one short-range wireless signal being not determined to be greater than the default threshold value, the terminal device is configured to classify the at least one short-range wireless signal of which the at least one RSSI is not greater than the default threshold value as at least one second short-range wireless signal, and to classify the at least one display device corresponding to the at least one second short-range wireless signal as at least one second class display device, and the terminal device is configured not to display the at least one second class display device.

In an embodiment of the disclosure, the display device includes a short-range wireless module, a processing module, and a display module. The short-range wireless module is configured to transmit the short-range wireless signal and to receive a connection request. The display module is configured to display an image. The processing module is electrically connected to the short-range wireless module and the display module and is configured to receive the connection code. The processing module is configured to control the short-range wireless module to continuously transmit the short-range wireless signal when the display device is in a shutdown mode or a standby mode.

In an embodiment of the disclosure, the display device is configured to input the MAC address into an encryption algorithm, and to utilize an encryption key to perform calculation on the MAC address by the encryption algorithm in order to generate the verification code.

In an embodiment of the disclosure, the terminal device is configured to input the MAC address into an encryption algorithm, and to utilize an encryption key to perform calculation on the MAC address by the encryption algorithm in order to generate the connection code.

In an embodiment of the disclosure, the display device is configured to transmit the short-range wireless signal by an iBeacon protocol, and the terminal device is configured to transmit the connection code to the display device by the iBeacon protocol or a Bluetooth protocol.

In order to achieve one, one part or all of the objectives, the method of generating the connection code for the display device in one embodiment of the disclosure includes: performing steps as follows by the terminal device: receiving the short-range wireless signal from the display device, wherein the short-range wireless includes the MAC address of the display device; according to the MAC address, generating the connection code.

In view of the above description, in the method of generating the connection code for the display device of the disclosure, the terminal device generates the connection code according to the MAC address of the short-range wireless signal, and a user does not need to input the connection code into the terminal device by hands, thereby reducing the complexity of manipulation and improving user experience.

In view of the above description, the method of verifying the connection of the display device of the disclosure and the connection verification system of the disclosure perform the security verification of the wireless connection on the terminal device according to the connection code of the terminal device and the verification code of the display device to prevent the display device from the access and the control of the terminal device which is not authorized.

In addition, when the display device such as the projector is in the shutdown mode or the standby mode, the method of verifying the connection of the display device of the disclosure and the connection verification system of the disclosure still perform the security verification can still perform the security verification of the wireless connection on the terminal device, thereby enhancing the security of the wireless connection between the terminal device and the display device.

### BRIEF DESCRIPTION OF THE DRAWINGS

FIG. 1 depicts the schematic diagram of a connection verification system according to one embodiment of the disclosure.

FIG. 2 depicts the block diagram of the display device according to one embodiment of the disclosure.

FIG. 3 depicts the schematic diagram of a connection verification system according to another embodiment of the disclosure.

FIG. 4 depicts the flowchart of a method of generating a connection code for a display device according to one embodiment of the disclosure.

FIG. 5 depicts the flowchart of a method of verifying a connection of a display device according to one embodiment of the disclosure.

FIG. 6 depicts the flowchart of the step of determining whether to be wirelessly connected to a terminal device according to a connection code and a verification code according to one embodiment of the disclosure.

FIG. 7 depicts the flowchart of a method of verifying a connection of a display device according to another embodiment of the disclosure.

FIG. 8 depicts the flowchart of the step of displaying at least one display device of which the RSSI is greater than a default threshold value in a list according at least one RSSI of at least one short-range wireless signal according to another embodiment of the disclosure.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive. The use of “at least one of...and...” thereof herein may include “one or more of one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C.

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

A method of verifying the connection of a display device in the disclosure includes: performing steps as follows by the display device with a media access control (MAC) address: according to the MAC address, generating a verification code; transmitting a short-range wireless signal including the MAC address; according to a connection code transmitted by a terminal device and the verification code, determining whether to be wirelessly connected to the terminal device; performing steps as follows by the terminal device: receiving the short-range wireless signal with the MAC address; generating the connection code according to the MAC address; transmitting the connection code to the display device. It should be noted that the order of performing steps by the display device and the order of performing steps by the terminal device are not limited to the order described in the foregoing descriptions. The MAC address refers to a unique media access control identifier assigned to a network interface of an electronic device, for example a display device. The MAC address is a hardware-level identifier, typically represented as a 48-bit value, and is used for distinguishing the electronic device from other electronic devices within a wireless or wired communication network.

A connection verification system in the disclosure includes the display device and the terminal device. The display device is provided with the MAC address. The display device is configured to generate the verification code according to the MAC address, and to transmit the short-range wireless signal including the MAC address. The terminal device is wirelessly connected to the display device. The terminal device is configured to receive the short-range wireless signal and to generate the connection code according to the MAC address. The terminal device is configured to transmit the connection code to the display device, and the display device is configured to determine whether to be wirelessly connected to the terminal device according to the connection code and the verification code.

A method of generating a connection code for a display device in the disclosure includes: performing steps as follows by the terminal device: receiving the short-range wireless signal from the display device, and the short-range wireless includes the MAC address of the display device; according to the MAC address, generating the connection code.

In order to clearly understand the operation mechanisms of the method of verifying the connection of the display device, the connection verification system and the method of generating the connection code for the display device, the following would elaborate the operation mechanisms of the method of verifying the connection of the display device, the connection verification system and the method of generating the connection code for the display device by the embodiments and the accompanying drawings.

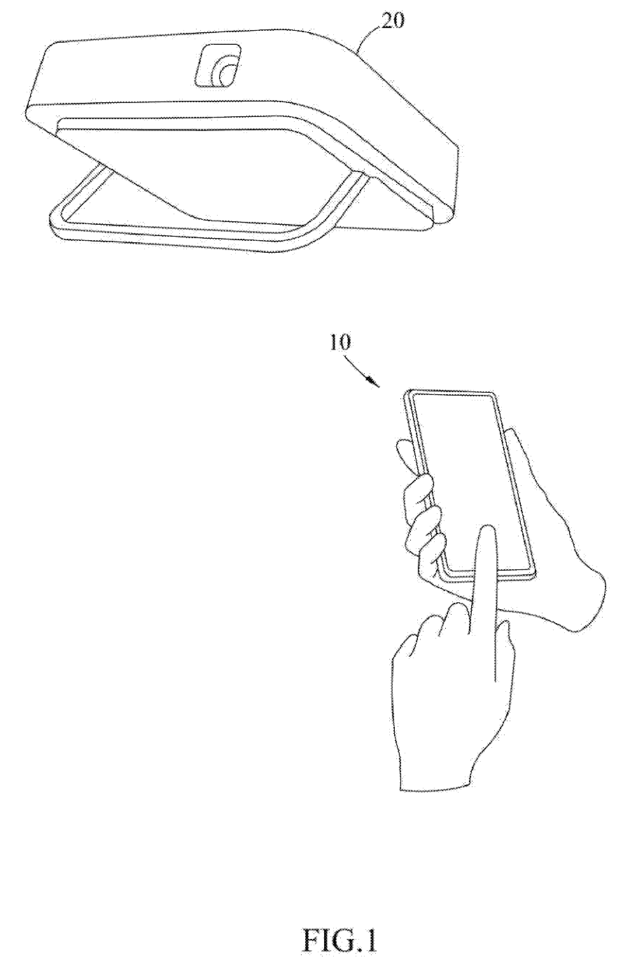

Please refer to FIG. 1, which depicts the schematic diagram of a connection verification system according to one embodiment of the disclosure. As shown in FIG. 1, the connection verification system includes the terminal device 10 and the display device 20. The display device 20, for example, may be a projector, is provided with the MAC address, and is configured to transmit the short-range wireless signal including the MAC address; for example, the short-range wireless signal is a Bluetooth signal. The terminal device 10, for example, may be a smartphone and wirelessly communicates with the display device 20 to receive the short-range wireless signal. The descriptions of generating the connection code according to the short-range wireless signal by the terminal device 10 will be elaborated in the paragraphs of the method of generating the connection code for the display device.

In other embodiments, the terminal device 10 may be a laptop or a tablet; definitely, the terminal device 10 may be also the other electronic device with a calculation function and a wireless communication function and not be limited thereto. The display device 20 may be a display or a television; definitely, the display device 20 may be also the other display device with a display function and the wireless communication function and not be limited thereto.

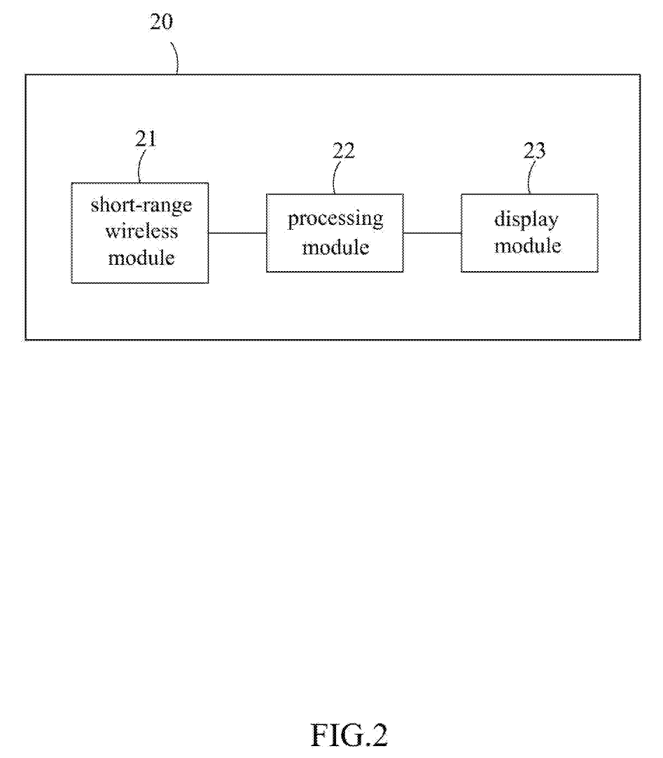

It should be explained that the terminal device 10 and the display device 20 separately have the fixed MAC addresses to be connected to a local area network (LAN). The MAC address of the terminal device 10 is different from the MAC address of the display device 20; in other words, the address on the LAN of the terminal device 10 is different from the address on the LAN of the display device 20. The display device 20 broadcasts the short-range wireless signal with the MAC address of the display device 20 to provide the terminal device 10 with detection or scan. When detecting or scanning the short-range wireless signal of the display device 20 is performed by the terminal device 10, the terminal device 10 receives the MAC address of the display device 20 from the short-range wireless signal of the display device 20. In other embodiment, the MAC address of the display device 20, for example, is the MAC address of the short-range wireless module 21 (referring to FIG. 2) of the display device 20.

Please refer to FIG. 2, which depicts the block diagram of the display device according to one embodiment of the disclosure. As shown in FIG. 2, the display device 20 such as the projector includes the short-range wireless module 21, a processing module 22 and a display module 23. The short-range wireless module 21, for example, is a Bluetooth circuit or Bluetooth’s IC and includes a wireless transceiver; the short-range wireless module 21 has a Bluetooth protocol and an iBeacon protocol and is configured to receive and transmit the short-range wireless signal by the Bluetooth protocol and the iBeacon protocol. Correspondingly, the wireless transceiver of the terminal device 10 also has the Bluetooth protocol and the iBeacon protocol to be configured to receive and transmit the short-range wireless signal.

In the embodiment, the short-range wireless module 21 is configured to transmit the short-range wireless signal by the iBeacon protocol, and the wireless transceiver of the terminal device 10 is configured to receive the short-range wireless signal from the short-range wireless module 21 by the iBeacon protocol. In another embodiment, the short-range wireless module 21 is configured to transmit the short-range wireless signal by the Bluetooth protocol, and the wireless transceiver of the terminal device 10 is configured to receive the short-range wireless signal from the short-range wireless module 21 by the Bluetooth protocol.

The display module 23 is configured to display an image. The display module 23 includes an illumination light source, a light valve and a projection lens, for example. The illumination light source generates and transmits an illumination light beam to the light valve, the light valve converts the illumination light beam into the image, and the projection lens projects the image outside the display device 20. For example, the illumination light source may include at least one light emitting diode or at least one laser diode to generate the illumination light beam with different colors, and the light valve may be a digital micromirror device (DMD), LCD panel or Liquid Crystal on Silicon (LCOS) panel.

The processing module 22 is electrically connected to the short-range wireless module 21 and the display module 23. The processing module 22 includes at least one processor, a programmable logic array (PLA) and an application-specific integrated circuit (ASIC), and selectively includes a memory unit or a storage unit; the processing module 22 is configured to receive and handle the short-range wireless signal from the short-range wireless module 21. The processing module 22 is configured to control the short-range wireless module 21 to transmit the short-range wireless signal to the processing module 22. The processing module 22 is configured to control the display module 23 to generate and display the image.

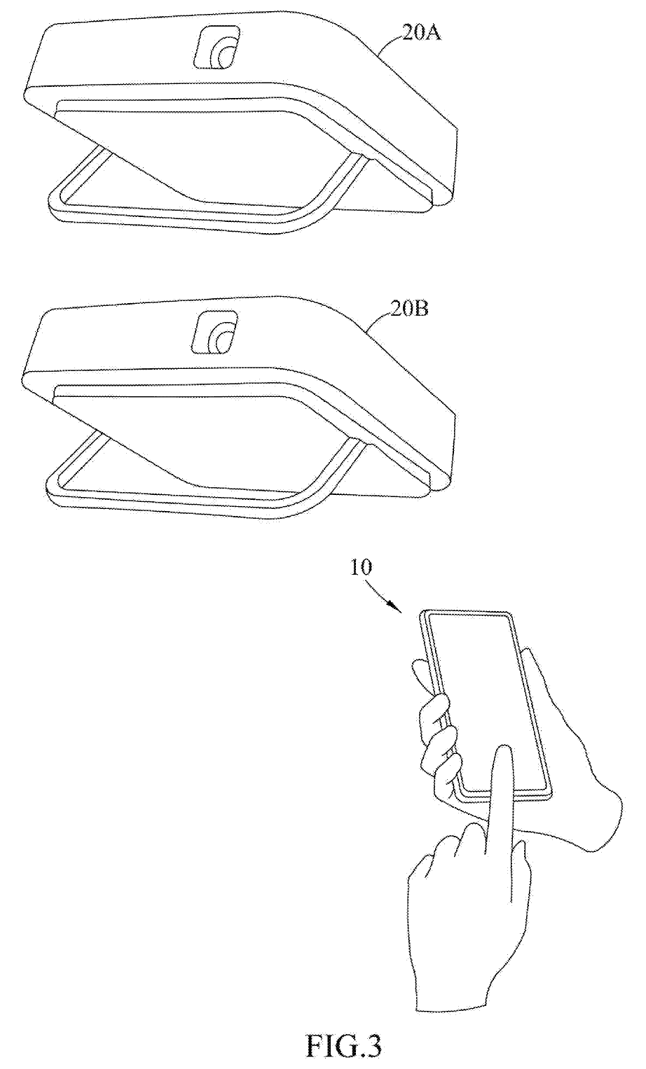

Please refer to FIG. 3, which depicts the schematic diagram of a connection verification system according to another embodiment of the disclosure. As shown in FIG. 3, the difference between the connection verification system shown in FIG. 3 and the connection verification system shown in FIG. 1 is: the number of the display devices is two, and two display devices are respectively denoted by 20A and 20B. Although the number of the display devices illustrated in FIG. 3 is two, the number of the display devices may be more than two and not be limited thereto. Similarly, the display devices 20A and 20B separately include the short-range wireless modules, the processing modules and the display modules, and the short-range wireless modules, the processing modules and the display modules of the display devices 20A and 20B are the same as the short-range wireless module 21, the processing module 22 and the display module 23 of the display device 20 and are not be repeated.

The terminal device 10 selectively displays or does not display the display device 20A and/or the display device 20B in a list according to the received signal strength indication (RSSI) of the short-range wireless signal from the display device 20A and the RSSI of the short-range wireless signal from the display device 20B. The details of selectively displaying or not displaying the display device in the list according to the RSSI of two short-range wireless signals will be elaborated in the paragraphs of the method of verifying the connection of the display device.

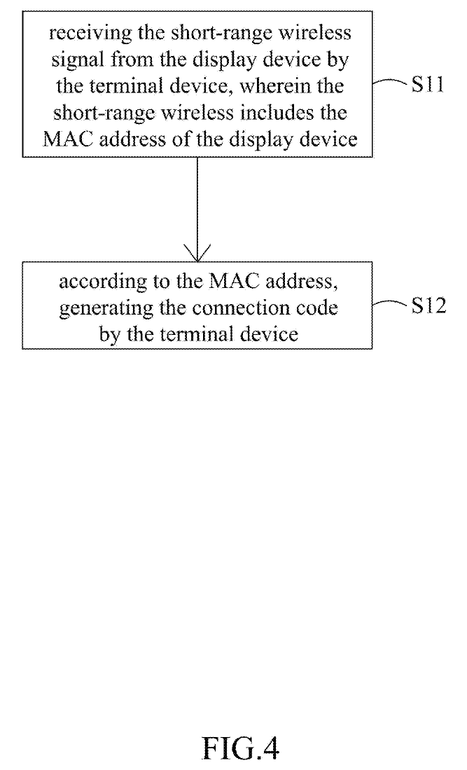

Please refer to FIG. 4, which depicts the flowchart of a method of generating a connection code for a display device according to one embodiment of the disclosure. As shown in FIG. 4, the method of generating the connection code for the display device includes step S11 and step S12. The following would explain step S11 and step S12 by the connection verification system shown in FIG. 1 and the display device 20 shown in FIG. 2.

Step S11: receiving the short-range wireless signal from the display device 20 by the terminal device 10, and the short-range wireless includes the MAC address of the display device 20. Specifically, the terminal device 10 is able to receive the short-range wireless signal from the display device 20 by the iBeacon protocol because the processing module 22 is able to control the short-range wireless module 21 to transmit the short-range wireless signal including the MAC address by the iBeacon protocol.

Step S12: according to the MAC address, generating the connection code by the terminal device 10. Specifically, the terminal device 10 receives the MAC address from the short-range wireless signal and generates the connection code according to the MAC address.

In the method of generating the connection code for the display device of the embodiment, the terminal device 10 automatically generates the connection code configured to be connected to the display device 20 according to the MAC address of the short-range wireless signal, and a user does not need to input the connection code into the terminal device 10 by hands, thereby raising the convenience of manipulation and simplifying the building of wireless connection.

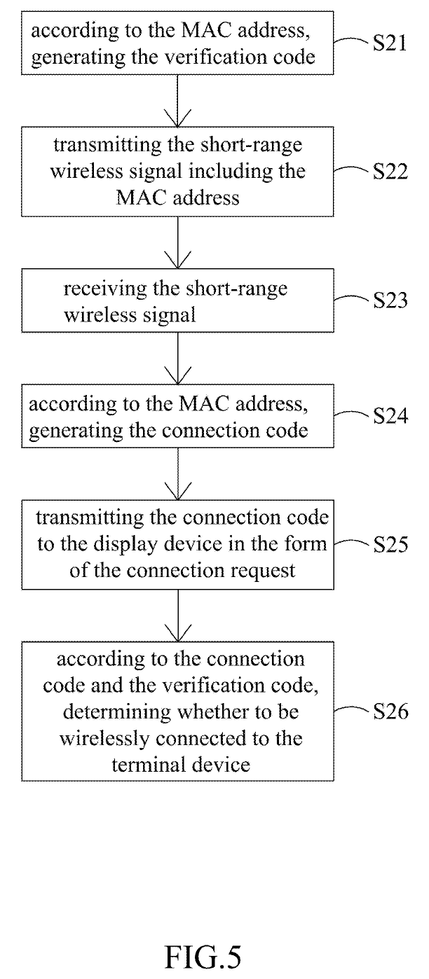

FIG. 5 depicts the flowchart of a method of verifying a connection of a display device according to one embodiment of the disclosure. As shown in FIG. 5, the method of verifying the connection of the display device includes step S21 to step S26. The following would explain step S21 to step S26 by the connection verification system shown in FIG. 1 and the display device 20 shown in FIG. 2. Step S21, step S22 and step S26 are performed by the display device 20, and step S24 and step S25 are performed by the terminal device 10.

Step S21: according to the MAC address, generating the verification code. Specifically, the processing module 22 is provided with an encryption algorithm and inputs the MAC address into the encryption algorithm, and the encryption algorithm performs the calculation on the MAC address by a specific encryption key to generate the verification code. For example, the encryption algorithm is a hash algorithm, and the encryption key is a hash key. The processing module 22 receives the last six hexadecimal number of the MAC address as an input sequence and combines the input sequence and the default hash key to form the input of the hash algorithm. Afterwards, the processing module 22 inputs the input of the hash algorithm into the hash algorithm, the hash algorithm outputs a hash value, and the processing module 22 receives a number sequence with a preset length as the verification code from the hash value.

It should be noted that the hash value is a string which consists of characters and numbers, and the processing module 22 receives one part of the string as the verification code instead of the entire string as the verification code; hence, the string length of the hash value is greater than the string length of the verification code. For example, the processing module 22 receives the last six symbols of the hash value as the verification code.

Step S22: transmitting the short-range wireless signal including the MAC address. Specifically, the processing module 22 transmits the short-range wireless signal including the MAC address to the short-range wireless module 21, and the short-range wireless module 21 transmits the short-range wireless signal including the MAC address by the iBeacon protocol or the Bluetooth protocol. When the display device 20 is in a shutdown mode or a standby mode, the processing module 22 controls the short-range wireless module 21 to continue to transmit the short-range wireless signal. Step S21 and step S22 may be synchronously performed or be separately performed.

Step S23: receiving the short-range wireless signal. Specifically, the wireless transceiver of the terminal device 10 utilizes the iBeacon protocol to receive the short-range wireless signal transmitted by the short-range wireless module 21 and transmits the short-range wireless signal to the processor of the terminal device 10.

Step S24: according to the MAC address, generating the connection code. Specifically, the processor of the terminal device 10 is provided with the encryption algorithm and inputs the MAC address into the encryption algorithm, and the encryption algorithm performs the calculation on the MAC address by the specific encryption key to generate the connection code. For example, the encryption algorithm is the hash algorithm, and the encryption key is the hash key. The processor of the terminal device 10 receives the last six hexadecimal number of the MAC address as the input sequence and combines the input sequence and the default hash key to form the input of the hash algorithm. Afterwards, the processor of the terminal device 10 inputs the input of the hash algorithm into the hash algorithm, the hash algorithm outputs the hash value, and the processor of the terminal device 10 receives the number sequence with the preset length as the connection code from the hash value.

It should be explained that the encryption algorithm and the encryption key corresponding to the processor of the terminal device 10 is the same as the encryption algorithm and the encryption key corresponding to the processing module 22. Correspondingly, the step of capturing performed on the MAC address by the processor of the terminal device 10 is the same as the step of capturing performed on the MAC address by the processing module 22; hence, the string length of the input sequence corresponding to the terminal device 10 is the same as the string length of the input sequence corresponding to the processing module 22. The step of capturing performed on the hash value by the processor of the terminal device 10 is the same as the step of capturing performed on the hash value by the processing module 22; hence, the preset length corresponding to the terminal device 10 is the same as the preset length corresponding to the processing module 22. The encryption key, the string length of the input sequence and the preset length may be an initial setup value or be set by the user.

Step S25: transmitting the connection code to the display device in the form of the connection request. Specifically, the processor of the terminal device 10 writes the connection code into the connection request and transmits the connection request to the wireless transceiver of the terminal device 10, and the connection request is the short-range wireless signal; at present, the processor of the terminal device 10 writes the MAC address of the terminal device 10 into the connection request to facilitate the wireless connection between the terminal device 10 and the display device 20. Afterwards, the wireless transceiver of the terminal device 10 transmits the connection request to the short-range wireless module 21 of the display device 20 by the iBeacon protocol or the Bluetooth protocol.

In the embodiment, the terminal device 10 automatically generates the connection code configured to be connected to the display device 20 according to the MAC address of the short-range wireless signal, automatically writes the connection code into the connection request, and transmits the connection request to the display device 20. Hence, by step S25, the user does not need to input the connection code for transmitting, thus raising the convenience of manipulation, simplifying the building of wireless connection and improving the manipulation experience of the user.

Step S26: according to the connection code from the terminal device 10 and the verification code, determining whether to be wirelessly connected to the terminal device 10. Specifically, the processing module 22 receives the connection request from the short-range wireless module 21, receives the connection code from the connection request, and compares the connection code with the verification code to determine whether the terminal device 10 passes security verification.

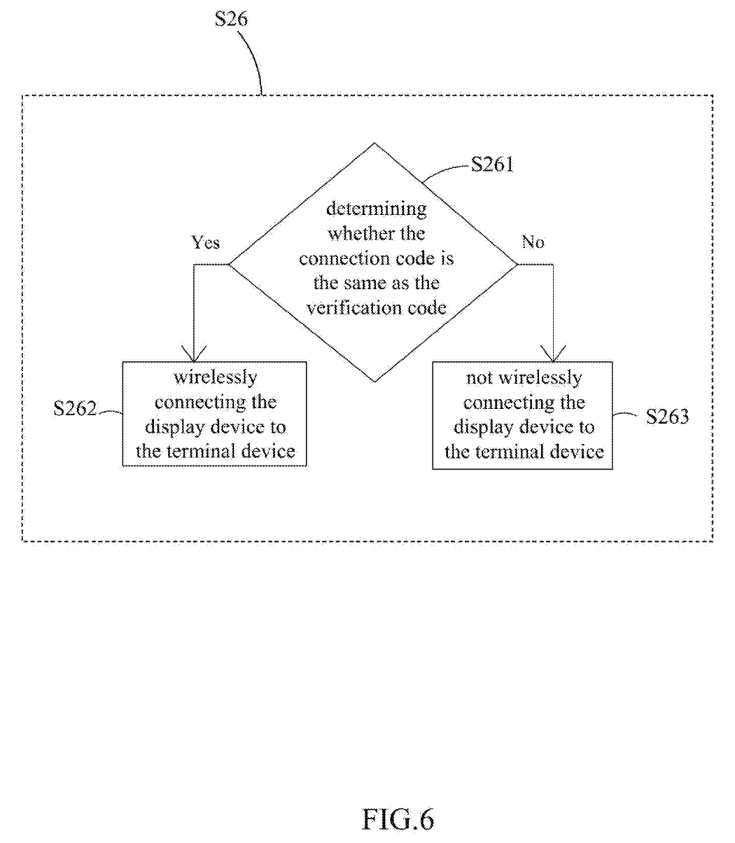

Please further refer to FIG. 6, which depicts the flowchart of the step of determining whether to be wirelessly connected to a terminal device according to a connection code and a verification code according to one embodiment of the disclosure. As shown in FIG. 6, step S26 includes step S261 to step S263.

Step S261: determining whether the connection code is the same as the verification code. Specifically, the processing module 22 compares whether the connection code is the same as the verification code to determine whether the terminal device 10 has an access to the display device 20. In response to determining that the connection code is the same as the verification code by the processing module 22, the processing module 22 determines that the terminal device 10 passes the security verification and has the access to the display device 20 and subsequently performs step S262. In response to determining that the connection code is not the same as the verification code by the processing module 22, the processing module 22 determines that the terminal device 10 does not pass the security verification and does not have the access to the display device 20 and subsequently performs step S263.

Step S262: wirelessly connecting the display device 20 to the terminal device 10. Specifically, the processing module 22 allows the access of the terminal device 10 and controls the short-range wireless module 21 to be wirelessly connected to the wireless transceiver of the terminal device 10 according to the MAC address of the terminal device 10, thus building the Bluetooth connection between the terminal device 10 and the display device 20. When the display device 20 is wirelessly connected to the terminal device 10, the terminal device 10 may control the display device 20; for example, the terminal device 10 may control the display device 20 to enter a boot mode or to control or adjust the display function of the display device 20.

Step S263: not wirelessly connecting the display device 20 to the terminal device 10. Specifically, the processing module 22 does not allow the access of the terminal device 10 and controls the short-range wireless module 21 not to be wirelessly connected to the wireless transceiver of the terminal device 10.

In the method of verifying the connection of the display device of the embodiment, the wireless connection between the terminal device and the display device is selectively allowed according to the connection code and the verification code, thereby preventing the display device from the access or the control of the terminal device which does not pass the security verification. When the display device such as the projector is in the shutdown mode or the standby mode, the method of verifying the connection of the display device of the embodiment can still be implemented to perform the security verification on the terminal device, thereby enhancing the security of the wireless connection between the terminal device and the display device and ensuring that the display device is prevented from the access or the control of the terminal device which does not pass the security verification or the terminal device or the terminal device which is not authorized. It should be noted that the order of performing steps by the display device and the order of performing steps by the terminal device are not limited to the order described in the foregoing descriptions.

In addition, the method of verifying the connection of the display device of the embodiment is applicable to the various projectors with the short-range wireless communication (e.g., Bluetooth) function and is not limited to the specific type display device, thereby enhancing the versatility and the practicality of the method of verifying the connection of the display device of the embodiment.

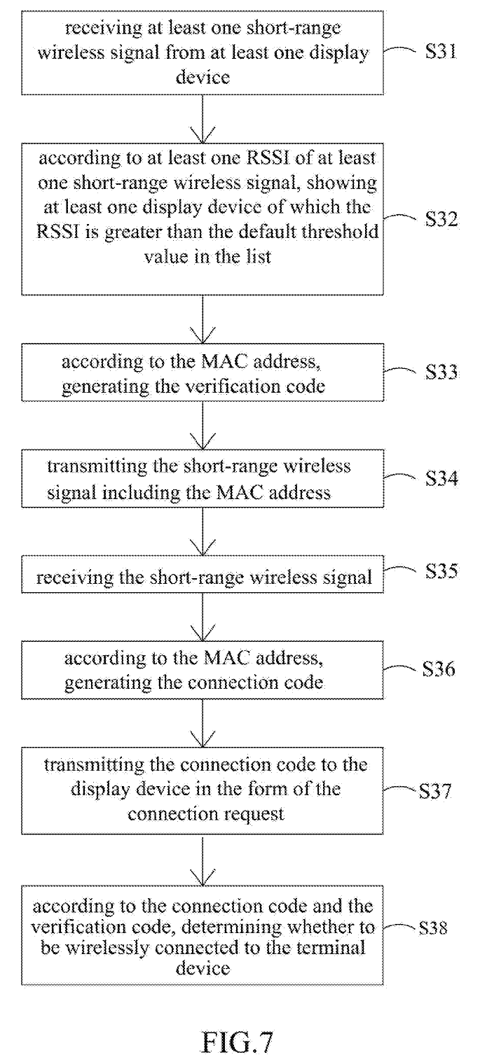

Please refer to FIG. 7, which depicts the flowchart of a method of verifying a connection of a display device according to another embodiment of the disclosure. As shown in FIG. 7, the method of verifying the connection of the display device includes step S31 to step S38, and step S33 to step S38 are the same as step S21 to step S26 and are not be repeated. The following would explain step S31 and step S32 by the connection verification system shown in FIG. 3, and similarly, the connection verification system shown in FIG. 1 may be applicable to step S31 and step S32 to perform the connection selection of the display device.

Step S31: receiving at least one short-range wireless signal from at least one display device. In step S31, the terminal device 10, for example, enters the coverage scope of the short-range wireless signal of the display devices 20A and 20B and does not have the Bluetooth connection with the display devices 20A and 20B. Afterwards, the wireless transceiver of the terminal device 10 receives two short-range wireless signals corresponding to the display devices 20A and 20B by the iBeacon protocol.

Step S32: according to at least one RSSI of at least one short-range wireless signal, displaying at least one display device of which the RSSI is greater than the default threshold value in the list. Specifically, the processor of the terminal device 10 calculates two RSSI corresponding to two short-range wireless signals and performs categorization on two display devices according to two corresponding RSSI and the default threshold value (e.g., -70dbm, but not limited thereto) to selectively display at least one display device of which the RSSI is greater than the default threshold value. Specifically, the processor of the terminal device 10 controls the screen of the terminal device 10 to display the list including at least one display device of which the RSSI is greater than the default threshold value. The user selects one display device as a target display device from the list, and the target display device is the display device 20A or the display device 20B. Finally, the processor of the terminal device 10 controls the wireless transceiver of the terminal device 10 to transmit a handshaking message to the target display device, and the target display device may generate the verification code (performing step S33) and perform the following steps in response to receiving the handshaking message.

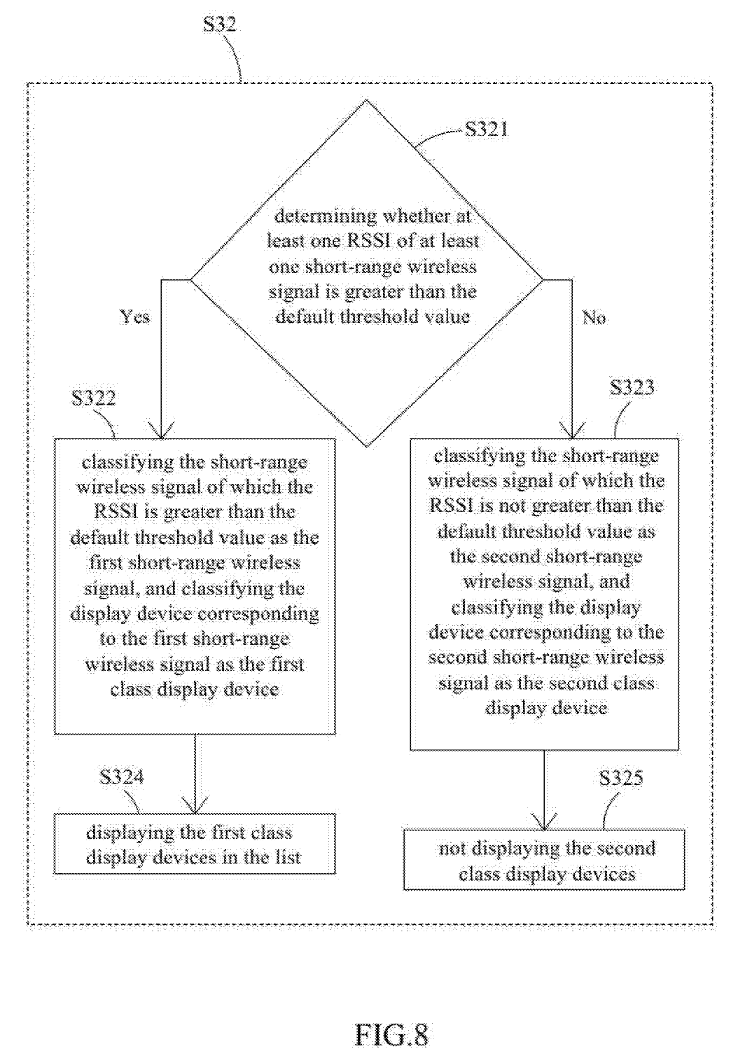

Moreover, please further refer to FIG. 8, which depicts the flowchart of the step of displaying at least one display device of which the RSSI is greater than the default threshold value in the list according at least one RSSI of at least one short-range wireless signal according to another embodiment of the disclosure. As shown in FIG. 8, step S32 includes step S321 to step S325.

Step S321: determining whether at least one RSSI of at least one short-range wireless signal is greater than the default threshold value. Specifically, the short-range wireless signal of which the RSSI is greater than the default threshold value is classified as one class, while the short-range wireless signal of which the RSSI is not greater than the default threshold value is classified as the other class. In response to determining that the RSSI of the short-range wireless signal is greater than the default threshold value by the processor of the terminal device 10, the processor of the terminal device 10 subsequently performs step S322. In response to determining that the RSSI of the short-range wireless signal is not greater than the default threshold value by the processor of the terminal device 10, the processor of the terminal device 10 subsequently performs step S323.

Step S322: classifying the short-range wireless signal of which the RSSI is greater than the default threshold value as a first short-range wireless signal, and classifying the display device corresponding to the first short-range wireless signal as a first class display device. Specifically, the processor of the terminal device 10 classifies the short-range wireless signal of which the RSSI is greater than the default threshold value as the first short-range wireless signal and classifies the display device corresponding to the first short-range wireless signal as the first class display device. The number of the first class display device may be one or more. For example, the RSSI of the short-range wireless signal of the display device 20A is greater than the default threshold value, and thus the processor of the terminal device 10 classifies the display device 20A as the first class display device.

Step S323: classifying the short-range wireless signal of which the RSSI is not greater than the default threshold value as a second short-range wireless signal, and classifying the display device corresponding to the second short-range wireless signal as a second class display device. Specifically, the processor of the terminal device 10 classifies the short-range wireless signal of which the RSSI is not greater than the default threshold value as the second short-range wireless signal and classifies the display device corresponding to the second short-range wireless signal as the second class display device. The number of the second class display device may be one or more. For example, the RSSI of the short-range wireless signal of the display device 20B is not greater than the default threshold value, and thus the processor of the terminal device 10 classifies the display device 20B as the second class display device.

Step S324: displaying the first class display devices in the list. Specifically, the processor of the terminal device 10 controls the screen of the terminal device 10 to display one or more first class display devices.

In the embodiment, the user selects one of the first class display devices as the target display device from the list displayed by the screen of the terminal device 10, and the target display device is the display device 20A, for example. The processor of the terminal device 10 controls the wireless transceiver of the terminal device 10 to transmit the handshaking message to the display device 20A, the display device 20A performs step S33 according to the handshaking message, and the wireless transceiver of the terminal device 10 transmits the short-range wireless signal including the MAC address of the terminal device 10 to the target display device (i.e., the display device 20A).

In another embodiment, the terminal device 10 may automatically select the target display device. For example, the display device 20A and the display device 20B are all the first class display devices, and the processor of the terminal device 10 selects the first class display device of which the RSSI is the greatest as the target display device. For example, the RSSI of the display device 20B is -45dBm, the RSSI of the display device 20A is -60dBm, and the processor of the terminal device 10 selects the display device 20B as the target display device. The processor of the terminal device 10 controls the wireless transceiver of the terminal device 10 to transmit the handshaking message to the display device 20B, the display device 20B performs step S33 according to the handshaking message, and the wireless transceiver of the terminal device 10 transmits the short-range wireless signal including the MAC address of the terminal device 10 to the target display device (i.e, the display device 20 B).

Step S325: not displaying the second class display devices. Specifically, the processor of the terminal device 10 controls the screen of the terminal device 10 not to display one or more second class display devices. In one embodiment, when there are only the second class display device, the terminal device 10 may further control the screen of the terminal device 10 to display a warning message, and the warning message indicates a distance problem or a security problem. In another embodiment, on a foundation of displaying the first class display device, the terminal device 10 may further display the second class display device and mark the warning message. In yet embodiment, when the RSSI of the first class display device (or the target display device) is not greater than the default threshold value (e.g., the user leaves the display device), the terminal device 10 may further control the screen of the terminal device 10 to display the warning message.

In the method of verifying the connection of the display device of the embodiment, whether the terminal device lies within the available connection scope of the display device (the wireless signal strength of the display device is greater than the default threshold value) is further considered so that only the terminal device lying within the available connection scope of the display device is able to be wirelessly connected to the display device and to transmit the connection code to the display device, and the display device performs the security verification on the terminal device lying within the available connection scope of the display device according to the verification code and the connection code. Hence, the method of verifying the connection of the display device of the embodiment utilizes the geographical position of the terminal device to add a safety barrier to the wireless connection security.

In addition, the method of verifying the connection of the display device of the embodiment may serve as application software, and the application software is applicable to mobile operating systems such as Android and iOS and computer operating systems such as windows. For example, the terminal device is a smart phone, and the application software including the method of verifying the connection of the display device of the embodiment is installed on the smart phone. The user selects and opens the application software on the screen of the smart phone and then changes the MAC address of the smart phone and sets the default threshold value. When the user moves and restarts the application software, the application software updates the displaying of the first class display device, the user reselects the appropriate first class display device, and the connection code changes accordingly.

In view of the above description, in the method of generating the connection code for the display device of the disclosure, the terminal device generates the connection code according to the MAC address of the short-range wireless signal, and the user does not need to input the connection code into the terminal device by the hands, thereby reducing the complexity of the manipulation and improving user experience.

In view of the above description, the method of verifying the connection of the display device of the disclosure and the connection verification system of the disclosure perform the security verification of the wireless connection on the terminal device according to the connection code of the terminal device and the verification code of the display device to prevent the display device from the access and the control of the terminal device which is not authorized.

In addition, when the display device such as the projector is in the shutdown mode or the standby mode, the method of verifying the connection of the display device of the disclosure and the connection verification system of the disclosure still perform the security verification can still perform the security verification of the wireless connection on the terminal device, thereby enhancing the security of the wireless connection between the terminal device and the display device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A method of verifying a connection of a display device comprising:
performing steps as follows by the display device with a MAC address:
according to the MAC address, generating a verification code;
transmitting a short-range wireless signal comprising the MAC address; and
according to a connection code transmitted by a terminal device and the verification code, determining whether to be wirelessly connected to the terminal device;
performing steps as follows by the terminal device:
receiving the short-range wireless signal with the MAC address;
generating the connection code according to the MAC address; and
transmitting the connection code to the display device.

2. The method of verifying the connection of the display device according to claim 1, wherein determining whether to be wirelessly connected to the terminal device according to the connection code and the verification code comprises:
determining whether the connection code is the same as the verification code;
in response to the connection code being determined to be the same as the verification code, wirelessly connecting the display device to the terminal device; and
in response to the connection code being not determined to be the same as the verification code, not wirelessly connecting the display device to the terminal device.

3. The method of verifying the connection of the display device according to claim 2, further comprising: controlling the display device by the terminal device in response to the display device being wirelessly connected to the terminal device.

4. The method of verifying the connection of the display device according to claim 1, further comprising:
performing steps as follows by the terminal device:
receiving at least one short-range wireless signal transmitted from at least one display device; and
according to at least one RSSI of the at least one short-range wireless signal, displaying, in a list, the at least one display device of which the at least one RSSI is greater than a default threshold value, wherein the at least one display device comprises the display device.

5. The method of verifying the connection of the display device according to claim 4, wherein displaying the at least one display device of which the at least one RSSI is greater than the default threshold value in the list according the at least one RSSI of the at least one short-range wireless signal comprises:
determining whether the at least one RSSI of the at least one short-range wireless signal is greater than the default threshold value;
in response to the at least one RSSI of the at least one short-range wireless signal being determined to be greater than the default threshold value, classifying the at least one short-range wireless signal of which the at least one RSSI is greater than the default threshold value as at least one first short-range wireless signal, and classifying the at least one display device corresponding to the at least one first short-range wireless signal as at least one first class display device; and
displaying the at least one first class display device in the list, wherein the at least one first class display device comprises the display device.

6. The method of verifying the connection of the display device according to claim 4, wherein displaying the at least one display device of which the at least one RSSI is greater than the default threshold value in the list according the at least one RSSI of the at least one short-range wireless signal comprises:
in response to the RSSI of the short-range wireless signal being not determined to be greater than the default threshold value, classifying the at least one short-range wireless signal of which the at least one RSSI is not greater than the default threshold value as at least one second short-range wireless signal, and classifying the at least one display device corresponding to the at least one second short-range wireless signal as at least one second class display device; and
not displaying the at least one second class display device.

7. The method of verifying the connection of the display device according to claim 1, wherein the display device is configured to continuously transmit the short-range wireless signal in response to the display device being in a shutdown mode or a standby mode.

8. The method of verifying the connection of the display device according to claim 1, wherein generating, by the display device, the verification code according to the MAC address comprises: inputting the MAC address into an encryption algorithm, and utilizing an encryption key to perform calculation on the MAC address by the encryption algorithm in order to generate the verification code.

9. The method of verifying the connection of the display device according to claim 1, wherein generating, by the terminal device, the connection code according to the MAC address comprises: inputting the MAC address into an encryption algorithm, and utilizing an encryption key to perform calculation on the MAC address by the encryption algorithm in order to generate the connection code.

10. A connection verification system comprising:
a display device provided with a MAC address, wherein the display device is configured to generate a verification code according to the MAC address, and to transmit a short-range wireless signal comprising the MAC address; and
a terminal device wirelessly connected to the display device, wherein the terminal device is configured to receive the short-range wireless signal and to generate a connection code according to the MAC address,
wherein the terminal device is configured to transmit the connection code to the display device, and the display device is configured to determine whether to be wirelessly connected to the terminal device according to the connection code and the verification code.

11. The connection verification system according to claim 10, wherein the display device is configured to determine whether the connection code is the same as the verification code, and
in response to the connection code being determined to be the same as the verification code, the display device is wirelessly connected to the terminal device; and
in response to the connection code being not determined to be the same as the verification code, the display device is not wirelessly connected to the terminal device.

12. The connection verification system according to claim 11, wherein the terminal device is configured to control the display device in response to the display device being wirelessly connected to the terminal device.

13. The connection verification system according to claim 10, wherein the at least one display device is configured to transmit at least one short-range wireless signal to the terminal device, the terminal device is configured to display the at least one display device of which at least one RSSI is greater than a default threshold value in a list according to the at least one RSSI of the at least one short-range wireless signal, and the at least one display device comprises the display device.

14. The connection verification system according to claim 13, wherein the terminal device is configured to determine whether the at least one RSSI of the at least one short-range wireless signal is greater than the default threshold value, and
in response to the at least one RSSI of the at least one short-range wireless signal being determined to be greater than the default threshold value, the terminal device is configured to classify the at least one short-range wireless signal of which the at least one RSSI is greater than the default threshold value as at least one first short-range wireless signal, and to classify the at least one display device corresponding to the at least one first short-range wireless signal as at least one first class display device; and
the terminal device is configured to display the at least one first class display device in the list, wherein the at least one first class display device comprises the display device.

15. The connection verification system according to claim 13, wherein in response to the at least one RSSI of the at least one short-range wireless signal being not determined to be greater than the default threshold value, the terminal device is configured to classify the at least one short-range wireless signal of which the at least one RSSI is not greater than the default threshold value as at least one second short-range wireless signal, and to classify the at least one display device corresponding to the at least one second short-range wireless signal as at least one second class display device, and
the terminal device is configured not to display the at least one second class display device.

16. The connection verification system according to claim 10, wherein the display device comprises:
a short-range wireless module configured to transmit the short-range wireless signal and to receive a connection request;
a display module configured to display an image; and
a processing module electrically connected to the short-range wireless module and the display module and configured to receive the connection code, and
wherein the processing module is configured to control the short-range wireless module to continuously transmit the short-range wireless signal when the display device is in a shutdown mode or a standby mode.

17. The connection verification system according to claim 10, wherein the display device is configured to input the MAC address into an encryption algorithm, and to utilize an encryption key to perform calculation on the MAC address by the encryption algorithm in order to generate the verification code.

18. The connection verification system according to claim 10, wherein the terminal device is configured to input the MAC address into an encryption algorithm, and to utilize an encryption key to perform calculation on the MAC address by the encryption algorithm in order to generate the connection code.

19. The connection verification system according to claim 10, wherein the display device is configured to transmit the short-range wireless signal by an iBeacon protocol, and the terminal device is configured to transmit the connection code to the display device by the iBeacon protocol or a Bluetooth protocol.

20. A method of generating a connection code for a display device comprising:
performing steps as follows by the terminal device:
receiving a short-range wireless signal from the display device, wherein the short-range wireless comprises a MAC address of the display device; and
according to the MAC address, generating a connection code.
